(19) United States
(12) Patent Application Publication
(10) Pub. No.: US 2016/0326421 A1
(43) Pub. Date: Nov. 10, 2016

(54) FLUID COMPOSITIONS AND METHODS OF USING NANOMATERIAL HYBRIDS

(71) Applicant: BAKER HUGHES INCORPORATED, Houston, TX (US)

(72) Inventor: Jianzhong Yang, Missouri City, TX (US)

(73) Assignee: BAKER HUGHES INCORPORATED, Houston, TX (US)

(21) Appl. No.: 14/703,282

(22) Filed: May 4, 2015

(51) Int. Cl. C09K 8/03; E21B 33/138; E21B 43/26; E21B 43/16; C09K 8/60; E21B 49/00

(52) U.S. Cl. CPC C09K 8/03; C09K 8/60; E21B 49/00; E21B 43/26; E21B 43/16; E21B 33/138; C09K 2208/10

(57) ABSTRACT

Hybrid nanomaterials may be introduced into fluids, such as drilling fluids, completion fluids, production fluids, stimulation fluids, and combinations thereof. The hybrid nanomaterials may increase the electrical and/or thermal conductivity, enhance the stability of an emulsion, improve wellbore strength, improve drag reduction properties, decrease corrosion, and the like. The hybrid nanomaterial(s) may be or include, but are not limited to, carbon black nanotube hybrids, coke nanotube hybrids, and combinations thereof.

### TECHNICAL FIELD

The present invention relates to fluid compositions and methods of using hybrid nanomaterials, such as carbon black nanotube hybrids, coke nanotube hybrids, and combinations thereof where the hybrid nanomaterials are present in a drilling fluid, a completion fluid, a production fluid, a stimulation fluid, and combinations thereof.

### BACKGROUND

Carbon black is a material produced by the incomplete combustion of heavy petroleum products, such as but not limited to, FCC tar, coal tar, ethylene cracking tar, vegetable oil, and combinations thereof. Carbon black has a high surface-area-to-volume ratio because of its paracrystalline carbon structure.

Carbon black has been mixed with many different materials to improve the properties of end use applications. For example, carbon black is widely used as a rubber-reinforcing filler in tires and various industrial rubber products, as well as a colorant for printing inks, paints, coatings, etc. Since the surface of carbon black largely comprises graphitic crystallites, it has a certain inherent degree of electrical conductivity and thus is also used as a filler for the purpose of imparting electrostatic properties to plastics, paints, and other non-conductive materials. In order to gain acceptable electrical conductivity without high loadings (and higher stiffness), carbon black may be chemically oxidized such that only a hollow “shell” of the graphitic carbon black structure remains. This has the effect of significantly reducing the density of the carbon black, allowing equivalent conductivity with a lower carbon black/polymer ratio.

Carbon black nanoparticles (or larger carbon black particles) have been added to downhole fluids to improve the electrical conductivity imparted to the fluid. However, the electrical conductivity of the carbon black nanoparticles does not seem to translate into the downhole fluids from the carbon black nanoparticles. In addition, carbon black nanoparticles may pose certain health risks for those handling the downhole fluids with the carbon black nanoparticles, and/or pose environmental risks to the formation once the downhole fluid has been circulated therein.

Thus, nanotubes have been included in downhole fluids to impart electrical conductivity properties thereto in hopes of alleviating the problems associated with carbon black nanoparticles, such as increasing electrical conductivity and decreasing any health or environmental risks. Carbon nanotubes may be formed from a graphene sheet rolled into a cylindrical sheet, which is also known as cylindrical fullerene. Carbon nanotubes are defined herein as allotropes of carbon consisting of one or several single-atomic layers of graphene rolled into a cylindrical nanostructure. Nanotubes may be single-walled, double-walled or multi-walled; nanotubes may also be open-ended or closed-ended. Nanotubes have high tensile strength, high electrical conductivity, high ductility, high heat conductivity, and relative chemical inactivity such that there are no exposed atoms that may be easily displaced. However, nanotubes are expensive to manufacture.

Downhole fluids, such as drilling fluids, completion fluids, stimulation fluids, fracturing fluids, acidizing fluids, and remediation fluids for subterranean oil and gas wells are known. Drilling fluids are typically classified according to their base fluid. In water-based fluids, solid particles are suspended in a continuous phase consisting of water or brine. Oil can be emulsified in the water, which is the continuous phase. “Water-based fluid” is used herein to include fluids having an aqueous continuous phase where the aqueous continuous phase can be all water or brine, an oil-in-water emulsion, or an oil-in-brine emulsion. Brine-based fluids, of course are water-based fluids, in which the aqueous component is brine.

Oil-based fluids are the opposite or inverse of water-based fluids. “Oil-based fluid” is used herein to include fluids having a non-aqueous continuous phase where the non-aqueous continuous phase is all oil, a non-aqueous fluid, a water-in-oil emulsion, a water-in-non-aqueous emulsion, a brine-in-oil emulsion, or a brine-in- non-aqueous emulsion. In oil-based fluids, solid particles are suspended in a continuous phase consisting of oil or another non-aqueous fluid. Water or brine can be emulsified in the oil; therefore, the oil is the continuous phase. In oil-based fluids, the oil may consist of any oil or water-immiscible fluid that may include, but is not limited to, diesel, mineral oil, esters, refinery cuts and blends, or alpha-olefins. Oil-based fluid as defined herein may also include synthetic-based fluids or muds (SBMs), which are synthetically produced rather than refined from naturally occurring materials. Synthetic-based fluids often include, but are not necessarily limited to, olefin oligomers of ethylene, esters made from vegetable fatty acids and alcohols, ethers and polyethers made from alcohols and polyalcohols, paraffinic, or aromatic, hydrocarbons alkyl benzenes, terpenes and other natural products and mixtures of these types.

For some applications, in particular for the use of some wellbore imaging tools, it is important to reduce the electrical resistivity (which is equivalent to increasing the electrical conductivity) of the oil-based fluid as the electrical conductivity of the fluids has a direct impact on the image quality. Certain resistivity logging tools, such as high resolution LWD tool STARTRAK™, available from Baker Hughes Inc, require the fluid to be electrically conductive to obtain the best image resolution. Water-based fluids, which are typically highly electrically conductive with a resistivity less than about 100 Ohm-m, are typically preferred for use with such tools in order to obtain a high resolution from the LWD logging tool.

However, oil based fluids are preferred in certain formation conditions, such as those with sensitive shales, or high pressure high temperature (HPHT) conditions where corrosion is abundant. Oil-based fluids are a challenge to use with high resolution resistivity tool, e.g. StarTrak™ because oil-based fluids have a low electrical conductivity (i.e. high resistivity). It would be highly desirable if fluid compositions and methods could be devised to increase the electrical conductivity of the oil-based or non-aqueous-liquid-based drilling, completion, production, and remediation fluids and thereby allow for better utilization of resistivity logging tools.

There are a variety of functions and characteristics that are expected of completion fluids. The completion fluid may be placed in a well to facilitate final operations prior to initiation of production. Completion fluids are typically brines, such as chlorides, bromides, formates, but may be any non-damaging fluid having proper density and flow characteristics. Suitable salts for forming the brines include, but are not necessarily limited to, sodium chloride, calcium chloride, zinc chloride, potassium chloride, potassium bromide, sodium bromide, calcium bromide, zinc bromide, sodium formate, potassium formate, ammonium formate, cesium formate, and mixtures thereof.

Chemical compatibility of the completion fluid with the reservoir formation and fluids is key. Chemical additives, such as polymers and surfactants are known in the art for being introduced to the brines used in well servicing fluids for various reasons that include, but are not limited to, increasing viscosity, and increasing the density of the brine. Water-thickening polymers serve to increase the viscosity of the brines and thus retard the migration of the brines into the formation and lift drilled solids from the wellbore. A regular drilling fluid is usually not compatible for completion operations because of its solid content, pH, and ionic composition. Completion fluids also help place certain completion-related equipment, such as gravel packs, without damaging the producing subterranean formation zones. Modifying the electrical conductivity and resistivity of completion fluids may allow the use of resistivity logging tools for facilitating final operations.

A stimulation fluid may be a treatment fluid prepared to stimulate, restore, or enhance the productivity of a well, such as fracturing fluids and/or matrix stimulation fluids in one non-limiting example.

Servicing fluids, such as remediation fluids, workover fluids, and the like, have several functions and characteristics necessary for repairing a damaged well. Such fluids may be used for breaking emulsions already formed and for removing formation damage that may have occurred during the drilling, completion and/or production operations. The terms “remedial operations” and “remediate” are defined herein to include a lowering of the viscosity of gel damage and/or the partial or complete removal of damage of any type from a subterranean formation. Similarly, the term “remediation fluid” is defined herein to include any fluid that may be useful in remedial operations.

Before performing remedial operations, the production of the well must be stopped, as well as the pressure of the reservoir contained. To do this, any tubing-casing packers may be unseated, and then servicing fluids are run down the tubing-casing annulus and up the tubing string. These servicing fluids aid in balancing the pressure of the reservoir and prevent the influx of any reservoir fluids. The tubing may be removed from the well once the well pressure is under control. Tools typically used for remedial operations include wireline tools, packers, perforating guns, flow-rate sensors, electric logging sondes, etc.

It would be desirable if the aforementioned downhole fluid compositions and methods for using such fluids could be tailored to enhance the electrical properties of the fluid composition yet decrease the environmental and health risks associated with such downhole fluids.

### SUMMARY

There is provided, in one non-limiting form, a fluid composition comprising a base fluid and at least one hybrid nanomaterial. The base fluid may be or include, but is not limited to, a drilling fluid, a completion fluid, a production fluid, a stimulation fluid, and combinations thereof. The hybrid nanomaterial(s) may be or include a carbon black nanotube hybrid, a coke nanotube hybrid, and combinations thereof.

In an alternative embodiment of the fluid composition, the amount of the hybrid nanomaterial(s) within the fluid composition may range from about 0.0001 wt % to about 25 wt %. The fluid composition may also include at least one surfactant in an amount effective to suspend the at least one hybrid nanomaterial in the base fluid.

In another non-limiting form, a method may include circulating a fluid composition into a subterranean reservoir wellbore. The fluid composition may have or include a base fluid and at least one hybrid nanomaterial. The base fluid may be or include, but is not limited to, a drilling fluid, a completion fluid, a production fluid, a stimulation fluid, and combinations thereof. The hybrid nanomaterial(s) may be or include a carbon black nanotube hybrid, a coke nanotube hybrid, and combinations thereof.

In an alternative non-limiting form of the method, the method may include performing a procedure selected from the group consisting of well logging, drilling a well, completing a well, fracturing a formation, acidizing a formation, cementing a subterranean reservoir wellbore, altering the wettability of a formation surface, altering the wettability of a wellbore surface, and combinations thereof. The fluid composition used as part of the method may include at least one surfactant in an amount effective to suspend the hybrid nanomaterial(s) in the base fluid.

### DETAILED DESCRIPTION

It has been discovered that a fluid composition having at least one hybrid nanomaterial in a base fluid may improve at least one property of the base fluid prior to circulating the fluid composition in a subterranean reservoir wellbore. The hybrid nanomaterial(s) may be or include, but are not limited to, a carbon black nanotube hybrid, a coke nanotube hybrid, and combinations thereof. The fluid may be or include, but is not limited to a drilling fluid, a completion fluid, a stimulation fluid, and combinations thereof.

“Hybrid nanomaterial” refers to a carbon black component or a coke component having a carbon nanotube extending from an outer surface of the carbon black component and/or coke component. In one non-limiting embodiment, the carbon black nanotube hybrid nanomaterial comprises a carbon black component having an outer surface as a catalyst support or substrate for growing carbon nanotubes (CNT) on the carbon black particle. At least one CNT may be formed directly on a carbon black particle and extend from the outer surface of the carbon black particle such that the carbon black particles form substrates o carry the CNT(s).

The carbon black component and/or coke component of the hybrid nanomaterials may be in the form of a particle, an aggregate, or an agglomerate. “Particles” may be carbon black or coke components formed at the early stages of the carbon black or coke synthesis process; particles cannot be subdivided by ordinary means. “Aggregate” refers to an accumulation of carbon black or coke particles that are fused together and tightly bonded. Carbon black or coke aggregates may not be broken down into individual particles through mechanical means, particularly when carbon black or coke aggregates are being combined with other materials in a mixing operation. “Agglomerate” refers to an accumulation of carbon black or coke aggregates that are generally held together by weaker physical (e.g., Van der Waals) forces and may be separated by mechanical means, such as during a mixing operation.

The carbon black component of the carbon black nanotube hybrid nanomaterials may be or include acetylene black, channel black, furnace black, lamp black, thermal black, carbon/silica hybrid blacks, and combinations thereof. The nanotube component of the carbon black nanotube hybrid nanomaterials may be or include a single-walled nanotube, a multi-walled nanotube, and combinations thereof.

In a non-limiting embodiment, the coke nanotube component of the coke nanotube hybrid nanomaterials may have or include a green coke component, a calcined coke component, and combinations thereof. The green coke component may be an insoluble organic deposit that has low hydrogen content typically formed from hydrocracking, thermal cracking, and/or distillation during the refining of crude oil or bitumen fluids. Coke is also known as pyrobitumen. Calcined coke may be created by placing the green coke into a rotary kiln and heating the green coke at a temperature ranging from about 200 C to about 1500 C to remove excess moisture, extract any remaining hydrocarbons, and modify the crystalline structure of the coke. The calcined coke has a denser more electrically conductive product than the green coke.

The hybrid nanomaterials may improve the electrical and/or thermal conductivity of the base fluid. Resistivity logging tools require the fluid in the wellbore to be electrically conductive. By including the hybrid nanomaterials in an oil-based fluid or a water-based fluid, the electrical and/or thermal conductivity thereof may be improved and thereby improve the images produced from the resistivity logging tools.

In addition, the nanotube component of either the carbon black nanotube hybrid nanomaterial or the coke nanotube hybrid nanomaterial may decrease the health/environmental risk associated with the use of carbon black nanoparticles or coke nanoparticles. The nanotube component would also increase the electrical conductivity of a carbon black nanoparticle or a coke nanoparticle. Likewise, by including the carbon black or coke component within the hybrid nanomaterial, manufacturing costs may decrease for manufacturing nanoparticles useful for increasing the electrical conductivity of a fluid composition.

The hybrid nanomaterials may be added or dispersed into at least one phase of the base fluid, such as the continuous phase in a non-limiting embodiment. In a non-limiting embodiment, the base fluid may be an emulsion, and the hybrid nanomaterials may improve the stability of the emulsion. In addition or in the alternative, the hybrid nanomaterials may strengthen a wellbore once the fluid composition has been circulated therein. Other benefits of the hybrid nanomaterials include reducing turbulence in a pipeline as a drag reducing agent, lubricating a drill bit, altering the wettability of a formation surface or a wellbore surface, decreasing corrosion to a surface (i.e. a drill bit, a pipeline, a wellbore, etc.), and the like.

The amount of hybrid nanomaterials present within the fluid composition may range from about 0.0001 wt % independently to about 25 wt %, alternatively from about 0.1 wt % independently to about 10 wt %, or from about 1 wt % independently to about 5 wt %.

To form the hybrid nanomaterials, a catalyst precursor may be deposited onto the carbon black or coke component to form a mixture. The catalyst precursor may be converted into a form suitable for catalyzing carbon nanotube grow, such as a form having a zero valent state in a non-limiting embodiment. The mixture may be heated in the presence of a carbon source to grow carbon nanotubes directly on the carbon black or coke component, and the mixture may be in contact with hydrogen gas to reduce the catalyst precursor. The resulting product may be cooled. The finished carbon black/CNT hybrid nonmaterial or finished coke/CNT hybrid nanomaterial may be cooled under a stream of gas, such as but not limited to argon gas, or a mixture hydrogen, helium, nitrogen, and/or argon. As an alternative, an oxidizing gas, such as oxygen, may also be used for the purpose of cleaning the surface of the product by combustion of amorphous carbon residue from the carbon black substrate or CNT attached thereon.

The catalyst precursor may be adsorbed and/or chemically bonded to the surface of the carbon black component or the coke component in a non-limiting embodiment. The catalyst precursor may be or include a metal or metal oxide particle, a metal salt, an organometallic compound (e.g. about 5% by weight of iron chloride). Such metals, metal oxides, metal salts, and the like may be or include group 6 metals (e.g. Cr, Mo, W), group 8-10 metals (e.g. Fe, Co, Ni), groups 11-14, and combinations thereof. Bimetallic catalysts having a combination of group 6, group 8, group 9, or group 10 metals may be beneficial in growing nanotubes onto the carbon black or coke components. The amount of the catalyst precursor deposited on the carbon black and/or coke component may range from about 0.1 wt % independently to about 20 wt %, or from about 1 wt % independently to about 10 wt % in another non-limiting embodiment.

The adsorbed or bonded catalyst metal precursor may be chemically reduced to a zero-valent state through the use of an effective reducing agent known to those familiar in the art. Non-limiting examples may include, but are not limited to, Na₂S₂O₄, NaH, CaH₂, LiAlH₄, BH₃, NaBH₄, and the like. The reducing agent may be added directly to the carbon black-metal precursor slurry or the coke-metal precursor slurry, or alternatively, the carbon black-catalyst metal precursor mix or coke-catalyst metal precursor mix may first be filtered and dried prior to reduction.

In a non-limiting embodiment, the catalyst may be calcined in air or another suitable gas for about an hour prior to reducing the mixture. The calcining of the catalyst may occur at a temperature ranging from about 300 C independently to about 1200 C, or from about 500 C independently to about 1000 C. The temperature and time required for sufficient CNT growth may vary, depending on the grade of carbon black chosen for the support, the type and quantity of CNT desired, and the selection of metal catalyst required to produce the desired CNT. In general, longer exposure times of the carbon black/catalyst or the coke/catalyst to the carbon-containing gas yield longer CNT or conversely, denser CNT coverage on the surface of the carbon black component or coke component.

In another non-limiting embodiment, the catalyst metal precursor may be added directly to a carbon black reactor or a coke reactor during carbon black formation or coke formation to adsorb or otherwise incorporate the catalyst metal precursor thereonto. The metal may be directly reduced in the reactor by a combination of the high reactor temperature and enriched hydrogen gas environment resulting from the rapid thermal decomposition of the hydrocarbon starting material during carbon black formation. Additional hydrogen gas could be added to the reactor, if necessary, in order to achieve adequate metal reduction.

The carbon black component or coke component having the zero-valent catalyst may be exposed to a carbon-containing gas at elevated temperature to achieve CNT growth on the surface thereof. Examples of suitable carbon-containing gases include aliphatic hydrocarbons, both saturated and unsaturated, such as methane, ethane, propane, butane, hexane, ethylene and propylene; carbon monoxide; oxygenated hydrocarbons such as acetone, acetylene and methanol; aromatic hydrocarbons such as toluene, benzene and naphthalene; and mixtures of the above, for example carbon monoxide and methane. Use of acetylene may promote formation of multi-wall carbon nanotubes, while CO and methane may form single-wall carbon nanotubes. The carbon-containing gas may optionally be mixed with a diluent gas, such as hydrogen, helium, nitrogen, or argon in a non-limiting embodiment.

In a non-limiting embodiment, the hybrid nanomaterials may include a carbon black component that is capped or non-capped, a nanotube component that is capped or non-capped, an optional nanocomponent different from the hybrid nanomaterials that is capped or non-capped, and combinations thereof. The optional nanocomponent may be or include, but is not limited to capped carbon-based particles different from the hybrid nanomaterials, non-capped carbon-based particles different from the hybrid nanomaterials, capped carbon-based particles, metal carbonyl particles, metal nanoparticles, and combinations thereof.

‘Carbon-based nanoparticles’ are defined herein to be nanoparticles having at least 50 mole % or greater of carbon atoms; ‘carbon-based nanoparticles’ is used herein to discuss other carbon-based nanoparticles that are different from the hybrid nanomaterials described. Non-limiting examples of carbon-based nanoparticles include, but are not limited to, graphene nanoparticles, graphene platelets, graphene oxide, nanorods, nanoplatelets, graphite nanoparticles, nanotubes that are not a component to a hybrid nanomaterial, carbon black nanoparticles that are not a component to a hybrid nanomaterial, and combinations thereof. The optional nanocomponent may be present in the fluid composition in an amount ranging from about 0.0001 wt % independently to about 25 wt %, alternatively from about 0.1 wt % independently to about 10 wt %, or from about 1 wt % independently to about 5 wt %.

Graphene is an allotrope of carbon having a planar sheet structure that has sp²-bonded carbon atoms densely packed in a 2-dimensional honeycomb crystal lattice. The term “graphene” is used herein to include particles that may contain more than one atomic plane, but still with a layered morphology, i.e. one in which one of the dimensions is significantly smaller than the other two, and also may include any graphene that has been functionally modified. The structure of graphene is hexagonal, and graphene is often referred to as a 2-dimensional (2-D) material. The 2-D morphology of the graphene nanoparticles is of utmost importance when carrying out the useful applications relevant to the graphene nanoparticles. The applications of graphite, the 3-D version of graphene, are not equivalent to the 2-D applications of graphene. The graphene may have at least one graphene sheet, and each graphene platelet may have a thickness no greater than 100 nm.

Graphene is in the form of one-atomic layer thick or multi-atomic layer thick platelets. Graphene platelets may have in-plane dimensions ranging from sub-micrometer to about 100 micrometers. This type of platelet shares many of the same characteristics as carbon nanotubes. The platelet chemical structure makes it easier to functionally modify the platelet for enhanced dispersion in polymers. Graphene platelets provide electrical conductivity that is similar to copper, but the density of the platelets may be about four times less than that of copper, which allows for lighter materials. The graphene platelets may also be fifty (50) times stronger than steel with a surface area that is twice that of carbon nanotubes.

Graphene may form the basis of several nanoparticle types, such as but not limited to the graphite nanoparticle, nanotubes, fullerenes, and the like. Several graphene sheets layered together may form a graphite nanoparticle. In a non-limiting embodiment, a graphite nanoparticle may have from about 2 layered graphene sheets to about 20 layered graphene sheets to form the graphite nanoparticle, or from about 3 layered graphene sheets to about 25 layered graphene sheets in another non-limiting example. Graphene nanoparticles may range from about 1 independently to about 50 nanometers thick, or from about 3 nm independently to about 25 nm thick.

Graphite nanoparticles are graphite (natural or synthetic) species downsized into a submicron size by a process, such as but not limited to a mechanic milling process to form graphite platelets, or a laser ablating technique to form a graphite nanoparticle having a spherical structure. The spherical structure may range in size from about 30 nm independently to about 999 nm, or from about 50 nm independently to about 500 nm. In a non-limiting embodiment, the spherical graphite nanoparticles may have a 3D structure. Graphite nanoparticles have different chemical properties because of the layered graphene effect, which allows them to be more electrically conductive than a single graphene sheet.

In another non-limiting embodiment, the graphene sheet may form a substantially spherical structure having a hollow inside, which is known as a fullerene. This cage-like structure allows a fullerene to have different properties or features as compared to graphite nanoparticles or graphene nanoparticles. For the most part, fullerenes are stable structures, but a non-limiting characteristic reaction of a fullerene is an electrophilic addition at 6,6 double bonds to reduce angle strain by changing an sp²-hydridized carbon into an sp³-hybridized carbon. In another non-limiting example, fullerenes may have other atoms trapped inside the hollow portion of the fullerene to form an endohedral fullerene. Metallofullerenes are non-limiting examples where one or two metallic atoms are trapped inside of the fullerene, but are not chemically bonded within the fullerene. Although fullerenes are not electrically conductive, alone, a functional modification to the fullerene may enhance a desired property thereto. Such functional modifications may be chemical modifications, physical modifications, covalent modifications, and/or surface modifications to form a functionalized fullerene.

A capped hybrid nanomaterial and/or a capped nanocomponent may have at least one oxygen species thereon that is capped to decrease the oxygen reactivity as compared to the non-capped hybrid nanomaterial and/or optional non-capped nanocomponent. The oxygen species that may be capped may include, but are not limited to carboxylic acids, ketones, lactones, anhydrides, hydroxyls, and combinations thereof present on or within the hybrid nanomaterial and/or optional nanocomponent.

It should be understood that the hybrid nanomaterials and/or optional nanocomponent(s) may be surface-modified nanoparticles, which may find utility in the compositions and methods herein. “Surface-modification” is defined here as the process of altering or modifying the surface properties of a particle by any means, including but not limited to physical, chemical, electrochemical or mechanical means, and with the intent to provide a unique desirable property or combination of properties to the surface of the hybrid nanomaterials and/or optional nanocomponent(s), which differs from the properties of the surface of the unprocessed hybrid nanomaterials and/or unprocessed optional nanocomponent(s).

In some non-limiting embodiments, the hybrid nanomaterials and/or nanocomponents may be functionally modified to form functionalized hybrid nanomaterials and/or functionalized optional nanocomponents, and capping the functionalized hybrid nanomaterials and/or optional functionalized nanocomponents may result in a semi-muted functionalization. Said differently, the capped functionalization may still maintain some of the functionalized characteristics imparted to the functionalized hybrid nanomaterials and/or functionalized optional nanocomponents, but to a lesser extent than a fully functionalized hybrid nanomaterials and/or optional nanocomponents that have not been capped. One skilled in the art would recognize when to cap or not cap a functionalized or non-functionalized hybrid nanomaterial and/or optional additional component.

The capping to the hybrid nanomaterials and/or optional nanocomponents may occur by use of a capping component, such as but not limited to, metal carbonyl species, metal nanoparticles, and combinations thereof. The capping may occur to the hybrid nanomaterials and/or optional nanocomponents by a method, such as but not limited to, physical capping, chemical capping, and combinations thereof. The hybrid nanomaterials and/or optional nanocomponents may or may not be functionally modified prior to capping the hybrid nanomaterials and/or optional nanocomponents. In a non-limiting embodiment, the hybrid nanomaterials and/or optional nanocomponents are capped (e.g. physical and/or chemical capping) when present within the base fluid.

A physical capping may occur by altering the ability of the oxygen species on or within the hybrid nanomaterials and/or optional nanocomponents by decreasing/eliminating electrostatic interactions, ionic interactions, and the like.

Alternatively, physical capping may occur by physical absorption of the oxygen species, such as by chemical vapor deposition under thermolysis in a non-limiting embodiment. In a non-limiting example, metal carbonyl species may be used to aid in physically capping the hybrid nanomaterials and/or optional nanocomponents nanoparticles, such as but not limited to platinum carbonyls, gold carbonyls, silver carbonyls, copper carbonyls, and combinations thereof. In an alternative non-limiting embodiment, metal nanoparticles may be used for physically capping the hybrid nanomaterials and/or optional nanocomponents, such as but not limited to platinum nanoparticles, gold nanoparticles, silver nanoparticles, copper nanoparticles, and combinations thereof.

In a non-limiting embodiment, the hybrid nanomaterials and/or optional nanocomponents may be encapsulated prior to physically capping the hybrid nanomaterials and/or optional nanocomponents; alternatively, the hybrid nanomaterials and/or optional nanocomponents may not be encapsulated prior to physically capping the hybrid nanomaterials and/or optional nanocomponents.

The amount of metal carbonyl species and/or the amount of metal nanoparticles for capping the hybrid nanomaterials and/or optional nanocomponents may range from about 0.1 wt % independently to about 10 wt % in a non-limiting embodiment, alternatively from about 1 wt % independently to about 5 wt %.

A chemical capping may occur by modifying chemical bonds of the hybrid nanomaterials and/or optional nanocomponents to alter the oxygen reactivity thereto, chemical absorption of the oxygen species, and the like. A non-limiting example of a chemical capping may include altering the polarity of an oxygen species of the hybrid nanomaterials and/or optional nanocomponents to be a non-polar or less polar oxygen species. Other non-limiting examples of chemical capping may occur by performing a reaction with the oxygen species with the appropriate reactant for each reaction, such as but not limited to a Grignard reaction, an alkyl esterification, an amidation, silanation with organic silanes, and combinations thereof. For each type of chemical capping reaction, the amount of respective reactants may range from about 1 wt % independently to about 5 wt %.

In a non-limiting embodiment, hybrid nanomaterials and/or optional nanocomponents may have at least one functional group attached thereto and/or may be covalently modified. Introduction of functional groups by derivatizing the olefinic functionality associated with the hybrid nanomaterial and/or optional nanocomponent may be affected by any of numerous known methods for direct carbon-carbon bond formation to an olefinic bond, or by linking to a functional group derived from an olefin. Exemplary methods of functionally modifying may include, but are not limited to, reactions such as oxidation or oxidative cleavage of olefins to form alcohols, diols, or carbonyl groups including aldehydes, ketones, or carboxylic acids; diazotization of olefins proceeding by the Sandmeyer reaction; intercalation/metallization of a nanodiamond by treatment with a reactive metal such as an alkali metal including lithium, sodium, potassium, and the like, to form an anionic intermediate, followed by treatment with a molecule capable of reacting with the metalized nanodiamond such as a carbonyl-containing species (carbon dioxide, carboxylic acids, anhydrides, esters, amides, imides, etc.), an alkyl species having a leaving group such as a halide (Cl, Br, I), a tosylate, a mesylate, or other reactive esters such as alkyl halides, alkyl tosylates, etc.; molecules having benzylic functional groups; use of transmetalated species with boron, zinc, or tin groups which react with e.g., aromatic halides in the presence of catalysts such as palladium, copper, or nickel, which proceed via mechanisms such as that of a Suzuki coupling reaction or the Stille reaction; pericyclic reactions (e.g., 3 or 4+2) or thermocyclic (2+2) cycloadditions of other olefins, dienes, heteroatom substituted olefins, and combinations thereof.

The covalent modification to hybrid nanomaterials and/or optional nanocomponents may include, but is not necessarily limited to, oxidation and subsequent chemical modification of oxidized hybrid nanomaterial and/or optional oxidized nanocomponents, fluorination, free radical additions, addition of carbenes, nitrenes and other radicals, arylamine attachment via diazonium chemistry, and the like. Besides covalent modification, chemical modification may occur by introducing noncovalent functionalization, electrostatic interactions, π-π interactions and polymer interactions, such as wrapping a hybrid nanomaterial and/or optional nanocomponent with a polymer, direct attachment of reactants to the hybrid nanomaterial and/or optional nanocomponents by attacking the sp² bonds, direct attachment to ends of the hybrid nanomaterial and/or optional nanocomponents or to the edges of the hybrid nanomaterial and/or optional nanocomponents, and the like.

It will be appreciated that the above methods are intended to illustrate the concept of functionally and/or covalently modifying the hybrid nanomaterials to introduce functional groups thereto, and should not be considered as limiting to such methods.

Prior to functional modification, the hybrid nanomaterials and/or optional nanocomponents may be exfoliated. Exemplary exfoliation methods include, but are not necessarily limited to, those practiced in the art, such as fluorination, acid intercalation, acid intercalation followed by thermal shock treatment, and the like. Exfoliation of the hybrid nanomaterial and/or optional nanocomponent provides the hybrid nanomaterial and/or optional nanocomponent having fewer layers than non-exfoliated graphene.

The effective medium theory states that properties of materials or fluids comprising different phases can be estimated from the knowledge of the properties of the individual phases and their volumetric fraction in the mixture. In particular if a conducting particle is dispersed in a dielectric fluid, the electrical conductivity of the dispersion will slowly increase for small additions of the hybrid nanomaterials and/or optional nanocomponents. As the hybrid nanomaterials and/or optional nanocomponents are continually added to the dispersion, the conductivity of the fluid increases, i.e. there is a strong correlation between increased conductivity and increased concentration of the hybrid nanomaterials and/or optional nanocomponents. This concentration is often referred to as the percolation limit.

In another non-limiting embodiment, the hybrid nanomaterial may be a functionalized hybrid nanomaterial having at least one functional group attached thereto. The functional group may be or include, but is not limited to, a sulfonate, a sulfate, a sulfosuccinate, a thiosulfate, a succinate, a carboxylate, a hydroxyl, a glucoside, an ethoxylate, a propoxylate, a phosphate, an ethoxylate, an ether, an amine, an amide, an alkyl, an alkenyl, a phenyl, benzyl, a perfluoro, thiol, an ester, an epoxy, a keto group, a lactone, a metal, an organometallic group, an oligomer, a polymer, and combinations thereof.

‘Functionalized’ is defined herein to be a hybrid nanomaterial or optional nanocomponent having an increased or decreased functionality, and the ‘functional modification’ is the process by which the hybrid nanomaterial or optional nanocomponent has had a particular functionality increased or decreased. The functionalized nanoparticles may have different functionalities than hybrid nanomaterials or optional nanocomponents that have not been functionally modified. In a non-limiting embodiment, the functional modification of the hybrid nanomaterials and/or optional nanocomponents may improve the dispersibility of the hybrid nanomaterials and/or optional nanocomponent in an oil-based fluid by stabilizing the hybrid nanomaterials and/or optional nanocomponent in suspension, which avoids undesirable flocculation as compared with otherwise identical hybrid nanomaterials and/or optional nanocomponent that have not been functionally modified. In one non-limiting embodiment of the invention, it is desirable that the conductivity properties of the fluid be uniform, which requires the distribution of the hybrid nanomaterials and/or optional nanocomponents to be uniform. If the hybrid nanomaterials and/or optional nanocomponent flocculate, drop out, or precipitate, the electrical conductivity of the fluid may change.

In addition or in the alternative non-limiting embodiment, the hybrid nanomaterial may be a covalently-modified hybrid nanomaterial having at least one covalent modification, such as but not limited to oxidation; free radical additions; addition of carbenes, nitrenes and other radicals; arylamine attachment via diazonium chemistry; and combinations thereof.

The fluid composition may be circulated into a subterranean reservoir wellbore. In a non-limiting embodiment, the fluid composition may be circulated into the subterranean reservoir wellbore to perform a procedure, such as but not limited to well logging, drilling a well, completing a well, fracturing a formation, acidizing a formation, cementing a subterranean reservoir wellbore, altering the wettability of a formation surface, altering the wettability of a wellbore surface, and combinations thereof.

A downhole tool may be operated with the fluid composition at the same time or different time as the circulating of the fluid composition. The downhole tool may have an improved image as compared to a downhole tool being operated at the same time or different time as a fluid composition absent the hybrid nanomaterials and optional nanocomponent(s).

Other benefits that may arise from modifying the electrical conductivity of the fluid composition may include enabling the implementation of measuring tools based on resistivity with superior image resolution, and improving the ability of a driller to improve its efficiency in the non-limiting instance of drilling fluids and/or completion fluids. It may also be conceivable that an electric signal may be able to be carried through the fluid composition across longer distances, such as across widely spaced electrodes in or around the bottom-hole assembly, or even from the bottom of the wellbore to intermediate stations or the surface of the well.

The final electrical conductivity of the downhole fluid composition may be determined by the content and the inherent properties of the dispersed phase content, which may be tailored to achieve desired values of electrical conductivity. The final resistivity (inverse of electrical conductivity) of the downhole fluid composition may range from about 0.02 ohm-m to about 1,000,000 ohm-m in one non-limiting embodiment. In an alternative embodiment, the resistivity of the fluid composition may range from about 0.2 ohm-m to about 10,000 ohm-m, or from about 2 ohm-m to about 1,000 ohm-m. As used herein with respect to a range, “independently” means that any threshold may be used together with another threshold to give a suitable alternative range, e.g. about 0.02 ohm-m independently to about 0.2 ohm-m is also considered a suitable alternative range.

In the present context, the hybrid nanomaterials and/or optional nanocomponent(s) may have at least one dimension less than 999 nm, alternatively less than 100 nm, or less than 50 nm in another non-limiting embodiment, although other dimensions may be larger than this. In a non-limiting embodiment, the hybrid nanomaterials and/or optional nanocomponent(s) may have one dimension less than 30 nm, or alternatively 10 nm. In one non-limiting instance, the smallest dimension of the hybrid nanomaterials and/or optional nanocomponent(s) may be less than 5 nm, but the length of the hybrid nanomaterials and/or optional nanocomponent(s) may be much longer than 100 nm, for instance 25000 nm or more. Alternatively, the average nanoparticle size of the hybrid nanomaterials and/or optional nanocomponent(s) are less than 999 nm, alternatively less than 100 nm, or less than 50 nm in another non-limiting embodiment. Such hybrid nanomaterials and/or optional nanocomponent(s) would be within the scope of the fluids herein.

The hybrid nanomaterials and/or optional additional nanocomponent(s) typically have at least one dimension less than 100 nm (one hundred nanometers). While materials on a micron scale have properties similar to the larger materials from which they are derived, assuming homogeneous composition, the same is not true of hybrid nanomaterials and/or optional nanocomponents. An immediate example is the very large interfacial or surface area per volume for the hybrid nanomaterials and/or optional nanocomponent(s). The consequence of this phenomenon is a very large potential for interaction with other matter, as a function of volume. For the hybrid nanomaterials and/or optional nanocomponent(s), the surface area may be up to 1800 m²/g. Additionally, because of the very large surface area to volume present with the hybrid nanomaterials and/or optional nanocomponent(s), it is expected that in most, if not all cases, much less proportion of the hybrid nanomaterials and/or optional nanocomponent(s) need be employed relative to micron-sized additives conventionally used to achieve or accomplish a similar effect.

In the case of electrical conductivity, conductivity of nanofluids (i.e. dispersion of the hybrid nanomaterials and/or optional nanocomponents in fluids), the percolation limit decreases with decreasing the size of the hybrid nanomaterials and/or optional nanocomponents. This dependence of the percolation limit on the concentration of the hybrid nanomaterials and/or optional nanocomponents holds for other fluid properties that depend on inter-particle average distance.

There is also a strong dependence on the shape of the hybrid nanomaterials and/or optional nanocomponents dispersed within the phases for the percolation limit of nano-dispersions. The percolation limit shifts further towards lower concentrations of the dispersed phase if the hybrid nanomaterials and/or optional nanocomponents have characteristic 2-D (platelets) or 1-D (nanotubes or nanorods) morphology. Thus the amount of 2-D or 1-D the hybrid nanomaterials and/or optional nanocomponents necessary to achieve a certain change in property is significantly smaller than the amount of 3-D the hybrid nanomaterials and/or optional nanocomponents that would be required to accomplish a similar effect.

In one sense, such fluids have made use of carbon-based nanoparticles for many years, since the clays commonly used in drilling fluids are naturally-occurring, 1 nm thick discs of aluminosilicates. Such carbon-based nanoparticles exhibit extraordinary rheological properties in water and oil. However, in contrast, the hybrid nanomaterials and/or optional nanocomponents that are the main topic herein are synthetically formed particles (whether included in the hybrid nanomaterials and/or in the optional nanocomponent) where size, shape and chemical composition are carefully controlled and give a particular property or effect.

The fluids herein may contain the hybrid nanomaterials and optional nanocomponents to improve the electrical conductivity of the fluids. In some cases, the hybrid nanomaterials and optional nanocomponents may change the properties of the fluids in which they reside, based on various stimuli including, but not necessarily limited to, temperature, pressure, rheology, pH, chemical composition, salinity, and the like. This is due to the fact that the hybrid nanomaterials and optional nanocomponents can be custom designed on an atomic level to have very specific functional groups, and thus the hybrid nanomaterials and optional nanocomponents react to a change in surroundings or conditions in a way that is beneficial. It should be understood that it is expected that hybrid nanomaterials and optional nanocomponents may have more than one type of functional group, making them multifunctional. Multifunctional hybrid nanomaterials and optional nanocomponents may be useful for simultaneous applications, in a non-limiting example of a fluid, lubricating the bit, increasing the temperature stability of the fluid, stabilizing the shale while drilling and provide low shear rate viscosity. In another non-restrictive embodiment, hybrid nanomaterials and optional nanocomponents suitable for stabilizing shale include those having an electric charge that permits them to associate with the shale.

In another non-limiting embodiment, the fluid composition may include a surfactant in an amount effective to suspend hybrid nanomaterials and optional nanocomponents in the base fluid. The surfactant may be present in the fluid composition in an amount ranging from about 1 vol % independently to about 10 vol %, or from about 2 vol % independently to about 8 vol % in another non-limiting embodiment.

The use of hybrid nanomaterials and optional nanocomponents may form self-assembly structures that may enhance the thermodynamic, physical, and rheological properties of these types of fluids. The hybrid nanomaterials and optional nanocomponents are dispersed in the base fluid. The base fluid may be a single-phase fluid or a poly-phase fluid, such as an emulsion of water-in-oil (W/O), oil-in-water (O/W), and the like. The hybrid nanomaterials and optional nanocomponents may be used in conventional operations and challenging operations that require stable fluids for high temperature and pressure conditions (HTHP).

Expected suitable surfactants may include, but are not necessarily limited to non-ionic, anionic, cationic, amphoteric surfactants and zwitterionic surfactants, janus surfactants, and blends thereof. Suitable nonionic surfactants may include, but are not necessarily limited to, alkyl polyglycosides, sorbitan esters, methyl glucoside esters, amine ethoxylates, diamine ethoxylates, polyglycerol esters, alkyl ethoxylates, alcohols that have been polypropoxylated and/or polyethoxylated or both. Suitable anionic surfactants may include alkali metal alkyl sulfates, alkyl ether sulfonates, alkyl sulfonates, alkyl aryl sulfonates, linear and branched alkyl ether sulfates and sulfonates, alcohol polypropoxylated sulfates, alcohol polyethoxylated sulfates, alcohol polypropoxylated polyethoxylated sulfates, alkyl disulfonates, alkylaryl disulfonates, alkyl disulfates, alkyl sulfosuccinates, alkyl ether sulfates, linear and branched ether sulfates, alkali metal carboxylates, fatty acid carboxylates, and phosphate esters. Suitable cationic surfactants may include, but are not necessarily limited to, arginine methyl esters, alkanolamines and alkylenediamides. Suitable surfactants may also include surfactants containing a non-ionic spacer-arm central extension, and an ionic or nonionic polar group. Other suitable surfactants may be dimeric or gemini surfactants, cleavable surfactants, janus surfactants and extended surfactants, also called extended chain surfactants.

Enhanced electrical conductivity of the fluid composition may form an electrically conductive filter cake that highly improves real time high resolution logging processes, as compared with an otherwise identical fluid absent the hybrid nanomaterials and optional nanocomponents.

In the foregoing specification, the invention has been described with reference to specific embodiments thereof, and has been suggested as effective in providing effective fluid compositions and methods for properties of a fluid composition having hybrid nanomaterials present therein. However, it will be evident that various modifications and changes may be made thereto without departing from the broader spirit or scope of the invention as set forth in the appended claims. Accordingly, the specification is to be regarded in an illustrative rather than a restrictive sense. For example, specific hybrid nanomaterials, specific nanocomponents, base fluids, surfactants, carbon black components, coke components, nanotube components, functional groups, and/or covalent modifications not specifically identified or tried in a particular fluid composition or method are anticipated to be within the scope of this invention.

The present invention may suitably comprise, consist or consist essentially of the elements disclosed and may be practiced in the absence of an element not disclosed. For instance, the fluid composition may consist of or consist essentially of a base fluid and at least one hybrid nanomaterial; the base fluid may be or include, but is not limited to, a drilling fluid, a completion fluid, a production fluid, a stimulation fluid, and combinations thereof; and the hybrid nanomaterial(s) may be or include a carbon black nanotube hybrid, a coke nanotube hybrid, and combinations thereof.

The method may consist of or consist essentially of circulating the fluid composition into a subterranean reservoir wellbore where the fluid composition may have or include a base fluid and at least one hybrid nanomaterial; the base fluid may be or include, but is not limited to, a drilling fluid, a completion fluid, a production fluid, a stimulation fluid, and combinations thereof; and the hybrid nanomaterial(s) may be or include a carbon black nanotube hybrid, a coke nanotube hybrid, and combinations thereof.

The words “comprising” and “comprises” as used throughout the claims is to be interpreted as meaning “including but not limited to”.

What is claimed is:

1. A fluid composition comprising:
a base fluid selected from the group consisting of a drilling fluid, a completion fluid, a production fluid, a stimulation fluid, and combinations thereof; and
at least one hybrid nanomaterial selected from the group consisting of a carbon black nanotube hybrid, a coke nanotube hybrid, and combinations thereof.

2. The fluid composition of claim 1, wherein the amount of the at least one hybrid nanomaterial within the fluid composition ranges from about 0.0001 wt % to about 25 wt %.

3. The fluid composition of claim 1 further comprising a nanocomponent selected from the group consisting of carbon-based particles different from the at least one hybrid nanomaterial, metal carbonyl particles, metal nanoparticles, and combinations thereof.

4. The fluid composition of claim 1, wherein the at least one hybrid nanomaterial is a coke nanotube hybrid comprising a coke component selected from the group consisting of green coke, a calcined coke, and combinations thereof.

5. The fluid composition of claim 1, wherein the at least one hybrid nanomaterial comprises at least one nanotube component selected from the group consisting of a single-walled nanotube, a multi-walled nanotube, and combinations thereof.

6. The fluid composition of claim 1, wherein the at least one hybrid nanomaterial is a functionalized hybrid nanomaterial having at least one functional group selected from the group consisting of a sulfonate, a sulfate, a sulfosuccinate, a thiosulfate, a succinate, a carboxylate, a hydroxyl, a glucoside, an ethoxylate, a propoxylate, a phosphate, an ethoxylate, an ether, an amine, an amide, an alkyl, an alkenyl, a phenyl, benzyl, a perfluoro, thiol, an ester, an epoxy, a keto group, a lactone, a metal, an organometallic group, an oligomer, a polymer, and combinations thereof. The fluid composition of claim 1, wherein the at least one hybrid nanomaterial is a covalently-modified hybrid nanomaterial having at least one covalent modification selected from the group consisting of oxidation; free radical additions; addition of carbenes, nitrenes and other radicals; arylamine attachment via diazonium chemistry; and combinations thereof.

8. The fluid composition of claim 1, further comprising at least one surfactant in an amount effective to suspend the at least one hybrid nanomaterial in the base fluid.

9. The fluid composition of claim 1, wherein the at least one hybrid nanomaterial has an average particle size less than about 999 nm.

10. A fluid composition comprising:
a base fluid selected from the group consisting of a drilling fluid, a completion fluid, a production fluid, a stimulation fluid, and combinations thereof;
at least one hybrid nanomaterial selected from the group consisting of a carbon black nanotube hybrid, a coke nanotube hybrid, and combinations thereof; wherein the amount of the at least one hybrid nanomaterial within the fluid composition ranges from about 0.0001 wt % to about 25 wt %; and
at least one surfactant in an amount effective to suspend the at least one hybrid nanomaterial in the base fluid.

11. A method comprising:
circulating a fluid composition into a subterranean reservoir wellbore; wherein the fluid composition comprises a base fluid selected from the group consisting of a drilling fluid, a completion fluid, a production fluid, a stimulation fluid, and combinations thereof; and wherein the fluid composition comprises at least one hybrid nanomaterial selected from the group consisting of a carbon black nanotube hybrid, a coke nanotube hybrid, and combinations thereof.

12. The method of claim 11, further comprising performing a procedure selected from the group consisting of well logging, drilling a well, completing a well, fracturing a formation, acidizing a formation, cementing a subterranean reservoir wellbore, altering the wettability of a formation surface, altering the wettability of a wellbore surface, and combinations thereof.

13. The method of claim 11, wherein the amount of the at least one hybrid nanomaterial within the fluid composition ranges from about 0.0001 wt % to about 25 wt %.

14. The method of claim 11, wherein the fluid composition further comprises a nanocomponent selected from the group consisting of carbon-based particles different from the at least one hybrid nanomaterial, metal carbonyl particles, metal nanoparticles, and combinations thereof.

15. The method of claim 11, wherein the at least one hybrid nanomaterial is a coke nanotube hybrid comprising a coke component selected from the group consisting of a green coke, a calcined coke, and combinations thereof.

16. The method of claim 11, wherein the at least one hybrid nanomaterial comprises at least one nanotube component selected from the group consisting of a single-walled nanotube, a multi-walled nanotube, and combinations thereof.

17. The method of claim 11, wherein the at least one hybrid nanomaterial is a functionalized hybrid nanomaterial having at least one functional group selected from the group consisting of a sulfonate, a sulfate, a sulfosuccinate, a thiosulfate, a succinate, a carboxylate, a hydroxyl, a glucoside, an ethoxylate, a propoxylate, a phosphate, an ethoxylate, an ether, an amine, an amide, an alkyl, an alkenyl, a phenyl, benzyl, a perfluoro, thiol, an ester, an epoxy, a keto group, a lactone, a metal, an organometallic group, an oligomer, a polymer, and combinations thereof.

18. The method of claim 11, wherein the at least one hybrid nanomaterial is a covalently-modified hybrid nanomaterial having at least one covalent modification selected from the group consisting of oxidation; free radical additions; addition of carbenes, nitrenes and other radicals; arylamine attachment via diazonium chemistry; and combinations thereof.

19. The method of claim 11, wherein the at least one hybrid nanomaterial has an average particle size less than about 999 nm.

20. A method comprising:
circulating a fluid composition into a subterranean reservoir wellbore;
wherein the fluid composition comprises a base fluid, at least one hybrid nanomaterial, and at least one surfactant in an amount effective to suspend the at least one hybrid nanomaterial in the base fluid; wherein the base fluid is selected from the group consisting of a drilling fluid, a completion fluid, a production fluid, a stimulation fluid, and combinations thereof; and wherein the at least one hybrid nanomaterial is selected from the group consisting of a carbon black nanotube hybrid, a coke nanotube hybrid, and combinations thereof; and
performing a procedure selected from the group consisting of well logging, drilling a well, completing a well, fracturing a formation, acidizing a formation, cementing a subterranean reservoir wellbore, altering the wettability of a formation surface, altering the wettability of a wellbore surface, and combinations thereof.
